(19) United States
(12) Patent Application Publication
(10) Pub. No.: US 2012/0152645 A1
(43) Pub. Date: Jun. 21, 2012

(54) WATER DRAIN VALVE COMPRISING AN UMBRELLA DIAPHRAGM

(75) Inventor: Michael Matthias, Diepoldsau (CH)

(73) Assignee: ThyssenKrupp Presta AG, Eschen (LI)

(21) Appl. No.: 13/394,041

(22) PCT Filed: Aug. 26, 2010
(86) PCT No.: PCT/EP2010/005228

§ 371 Date: Mar. 2, 2012

(30) Foreign Application Priority Data
Sep. 3, 2009 (DE) 10 2009 039 832.5

(51) Int. Cl. B62D 5/00; F16K 1/00

(52) U.S. Cl. 180/442; 251/331

(57) ABSTRACT

A water drain valve for an electromechanical motor vehicle power steering may include a base and a diaphragm which is configured as a movable valve element and is arranged such that it can move relative to the base between a closed position and an open position. In the closed position, the diaphragm rests against the base along an annular ring. The base may have a passage which extends from a free opening to a floor, with the diaphragm being attached centrally to the floor, the floor having at least one opening which forms a connection from the passage to the diaphragm, and the floor having at least one groove which is open towards the diaphragm and extends from the at least one opening as far as the annular ring.

The present invention relates to a water drain valve with a umbrella diaphragm and to an electromechanical power steering with a valve of this type.

Power steering systems for motor vehicles are generally known and are used universally. They assist the steering movement performed by the driver and thus allow easy actuation of the steering, in particular in the case of heavy vehicles. In the past, most of the power steering systems were driven hydraulically, with a hydraulic unit being arranged in the steering casing. These steering systems are effectively protected against penetrating water. Even water which has penetrated inside a steering system of this type is only critical in the longer term because it can result in corrosion.

In contrast, electromechanical power steering systems are latterly becoming increasingly widespread, in particular in relatively small vehicles. Electromechanical power steering systems have the advantage that they can be actuated in a very flexible manner by the electronic control and thus can be adapted to different purposes of use. They have the particular advantage that they do not require hydraulic fluid which presents problems during filling, maintenance and disposal. However, electromechanical power steering systems are relatively sensitive to penetrating water. In addition to corrosion of the numerous components of a steering system of this type, the electronic control can also be impaired, namely if sensor signals are falsified by water which has penetrated inside. Above all however, water can freeze at temperatures below 0 degrees Celsius in the steering and the ice which forms can then obstruct the steering.

Water can get into the steering in different ways. Thus, it is possible for one of the usually present bellows to be damaged. Water can penetrate into the region of electrical connections. Furthermore, at lower temperatures, water vapour can condense out of the atmospheric moisture of the air present in the system. Finally, the casing of the steering can itself become untight. When driving through flat puddles, the splashed water can penetrate inside the steering. If the water is so deep that the steering system is completely immersed, this is then referred to as so-called submerged travel. In the latter cases, it is also possible for larger amounts of water to penetrate inside the steering.

Therefore, electromechanical power steering systems are provided with water drain valves, the purpose of which is to automatically convey the penetrated water out of the steering system and to seal off the system from externally pervading water, particularly during submerged travel. Valves of this type are known from documents EP1747393 B1 and WO 2006119315 A2. Both documents disclose a valve with a diaphragm which on the one hand exhibits a sealing function and on the other exhibits a function for allowing a fluid to pass through from a container. However, both systems have a complicated construction and are unsuitable for use in an electromechanical steering system. A valve which satisfies the requirements imposed in automotive engineering must be of a simple construction, must reliably drain off even small amounts of water, present in drops, from the interior of the steering gear and must operate reliably under the prevailing environmental conditions. Finally, a valve in automotive engineering must not be constructed in too complex a manner in order to keep the cost and weight down.

The construction of a valve proposed in document DE 10 2006 036 214 A1 is also very complex, without thereby achieving advantageously fast switching speeds.

Document DE 4420586 C1 discloses a water drain valve according to the preamble of claim 1. In the mechanical construction which is shown, very small amounts of water are not completely drained away under low pressure. The same applies to the solution proposed in document DE 1228948 B.

The object of the present invention is to provide a water drain valve which satisfies these requirements. It is a further object of the present invention to provide an electromechanical power steering system which is reliably drained even when there are small quantities of penetrating water and which is reliably sealed off in the region of the valve from water penetrating from outside.

This object is achieved by a valve which has the features of claim 1 and by a power steering which has the features of claim 10. The subclaims provide advantageous developments of the invention.

Due to the fact that a water drain valve for an electromechanical power steering for a motor vehicle is provided with a base and a diaphragm which is configured as a movable valve element and is arranged such that it can move relative to the base between a closed position and an open position, and in the closed position, the diaphragm rests against the base along an annular ring, the base having a passage which extends from a free opening to a floor and the diaphragm being attached centrally to the floor, the floor having at least one opening which forms a connection from the passage to the diaphragm and the floor also having at least one groove which is open towards the diaphragm and extends from the at least one opening to the annular ring, even drops of water are drained off via the diaphragm.

If the at least one groove has a depth, measured in the direction of the axis and vertically to the floor surface, of from 0.1 mm to 0.9 mm, preferably from 0.2 mm to 0.4 mm and in particular 0.3 mm, particularly good characteristics of the water drainage are produced, especially in conjunction with a diaphragm which is made of silicone.

Accordingly, it is advantageous if the width of the groove is from 0.5 mm to 1.5 mm, preferably 1.0 mm.

The length of the at least one groove between the outer edges of the openings and the annular ring should be 1.5 mm to 4.5 mm, preferably 3 mm, and the groove does not necessarily have to extend exactly radially or exactly straight. The base of the groove is preferably rounded.

If the diaphragm comprises a round diaphragm disc which has a material thickness decreasing outwards from inside which, on the inside, is between 0.6 mm and 1.8 mm, preferably 1.2 mm and outside is accordingly between 0.45 mm and 1.35 mm, preferably 0.9 mm, the diaphragm is particularly movable and even opens when there are small quantities of water of from approximately 20 micro litres. In this respect, it is advantageous for the annular ring to also be round in shape and to be arranged concentrically to the diaphragm disc and in particular to surround the centre of the round diaphragm disc. The sealing contact between diaphragm surface and annular ring more preferably occurs with a diameter of approximately 13 to 20 mm.

The diaphragm is preferably attached by a central peg in a central hole in the floor so that it sits approximately rotationally symmetrically in the valve. This measure provides a reliable operation, even when there is an inclination in any direction.

The diaphragm becomes particularly movable when the peg has a centrally positioned blind hole in the manner of a blind hole.

The arrangement in a motor vehicle is simplified when the diaphragm is covered by a cover on its side remote from the base and is protected against mechanical damage, because a separate protection means is then not required for the valve. In addition, the space which forms thus can be used as a pressure chamber in the event of water penetrating inside and thus can effectively press the diaphragm against the sealing annular ring and facilitate the sealing procedure.

The invention also provides an electromechanical motor vehicle power steering system with a water drain valve, comprising:
a base which is arranged at a low point of a steering casing and a diaphragm which is configured as a movable valve element and is arranged such that it can move relative to the base between a closed position and an open position,
and in the closed position, the diaphragm rests against the base along an annular ring,
the base having a passage which is open towards an interior of the steering casing and extends from a free opening to a floor and the diaphragm being attached centrally to the floor by a peg,
the floor having at least one opening which forms a connection from the passage to the diaphragm and the floor having at least one groove which is open towards the diaphragm and extends from the at least one opening to the annular ring.

During the penetration of water, a steering of this type is drained in a particularly effective and reliable manner, the drainage taking place reliably even in the case of small quantities of water occurring as drops. For this purpose, it is advantageous for the diaphragm and/or the base, and optionally also the inside of the steering casing to have a hydrophobic surface.

The diaphragm is particularly protected when it is mounted between the base and a cover.

The interior of the steering, more precisely the interior of the steering gear is ventilated with respect to the atmosphere when the diaphragm does not rest against the annular ring over its entire extent in the non-operating state. The build-up of a pressure differential between the steering gear and the ambient air is then prevented. Nevertheless, the easy movability of the diaphragm ensures that water from outside does not penetrate inside the steering via the valve, because in this case, the diaphragm immediately closes.

In the following, exemplary embodiments of the present invention will be described in more detail with reference to the drawings, in which:

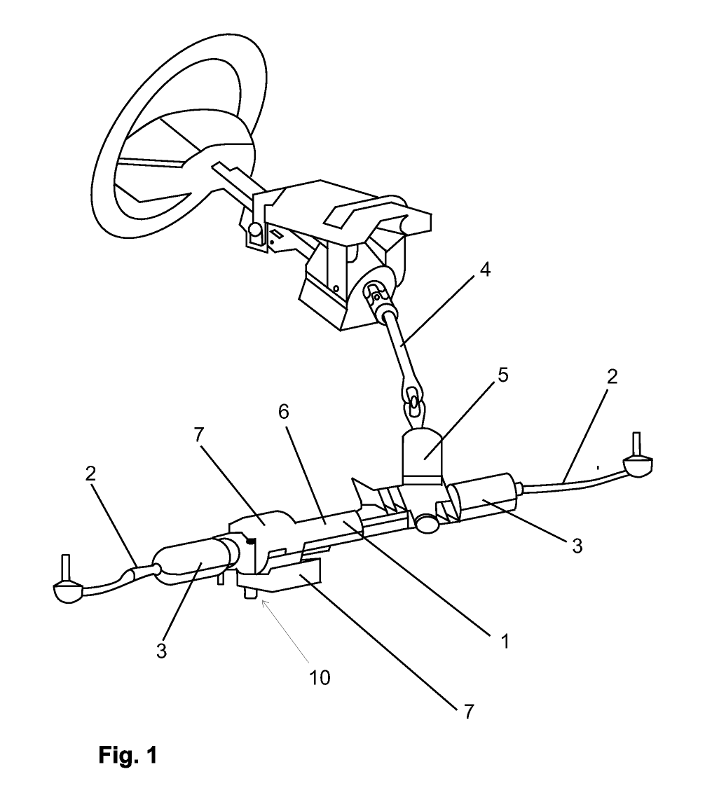

FIG. 1: is a perspective view of an electromechanical power steering with steering wheel and steering column;

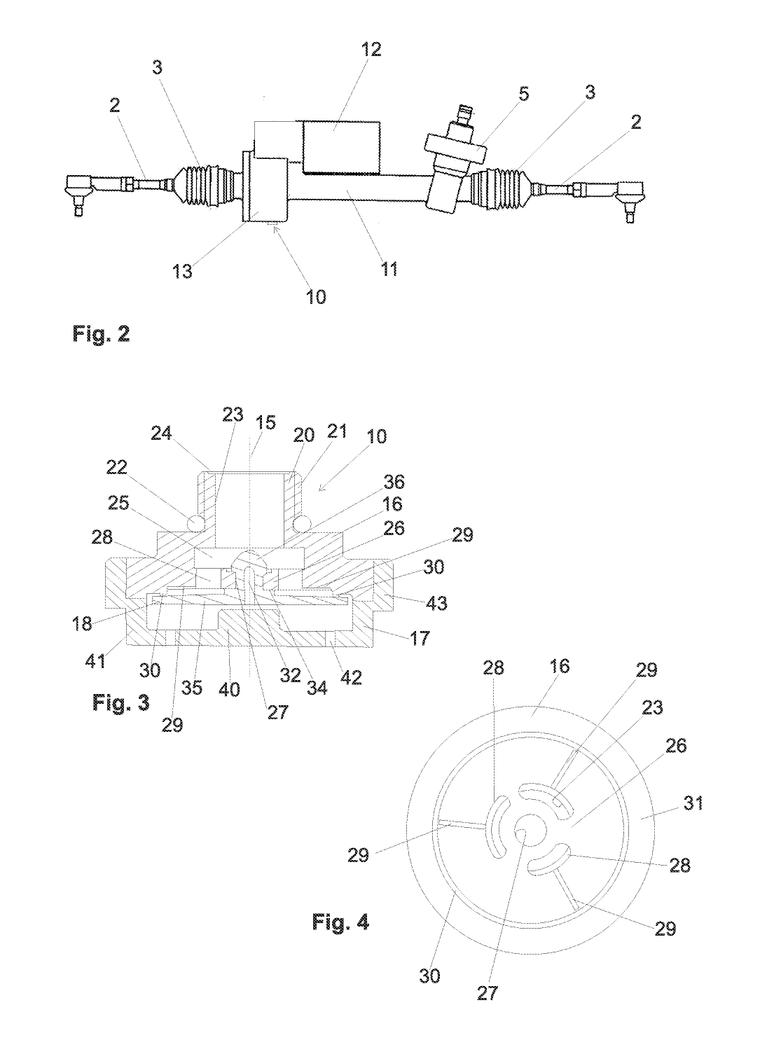

FIG. 2: is a view of an electromechanical steering gear in the direction of travel;

FIG. 3: is a lateral cross-sectional view of a first embodiment of a water drain valve;

FIG. 4: is a bottom view of the basic body of the valve of FIG. 3;

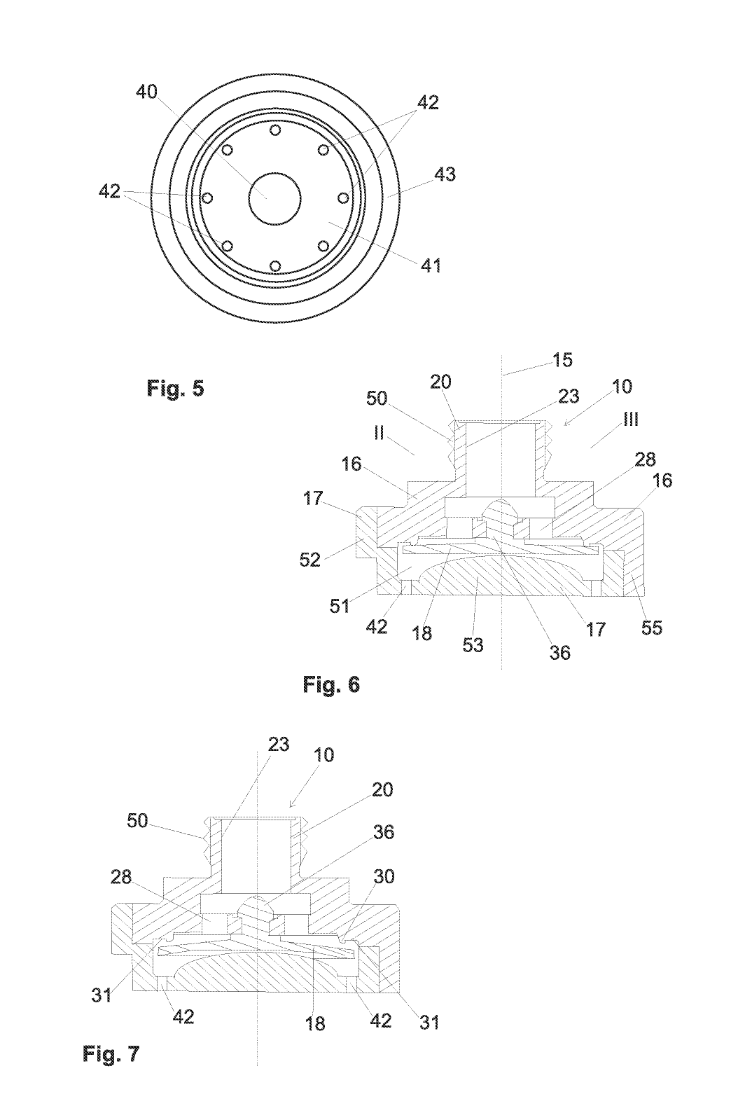

FIG. 5: is a plan view of the cover of the valve of FIG. 3;

FIG. 6: is a cross-sectional view of two other embodiments of the water drain valve, where the left half of FIG. 6 shows a second embodiment and the right half of FIG. 6 shows a third embodiment; and

FIG. 7: shows the two embodiments of FIG. 6 with an open valve element.

FIG. 1 shows an electromechanical power steering according to the invention with a steering gear 1 which, in a known manner, has a steering rack which is mounted in a longitudinally displaceable manner but is not shown here. The steering rack is articulated with two tie rods 2. The steering joint is encased by a respective bellows 3. The bellows 3 protects the interior of the steering gear 1 against environmental influences in the region of the movable components.

The steering rack is actuated by a steering column 4 and a tooth engagement so that, when the steering column 4 is turned, the steering rack and thus also the tie rods 2 are displaced in their longitudinal direction. The torque resulting therefrom in the steering column 4 is detected by a torque sensor 5. In this construction, an electrical servomotor 6 drives the steering rack to assist the driver. The type of construction shown in FIG. 1 corresponds to a hollow shaft motor which drives the steering rack, penetrating the hollow shaft motor, by a reduction gear. The servomotor 6 is arranged in a crankcase 7. In the installation position shown, the lowest point of the steering gear 1 is located on the crankcase 7. A water drain valve 10 is arranged at this lowest point.

Similarly, FIG. 2 shows a steering gear 11 with a torque sensor 5, tie rods 2, bellows 3 and an electric servomotor 12, the servomotor 12 being laterally offset relative to the steering rack. In the illustrated construction, the servomotor 12 drives the steering rack via a toothed belt transmission which runs in a gearbox case 13. In this construction, the lowest point of the steering gear is located on the gearbox case 13. The water drain valve 10 according to the invention is mounted at the lowest point, as in FIG. 1.

FIG. 3 is a longitudinal sectional view of the water drain valve 10 in a first embodiment in the installed position according to FIG. 1 or FIG. 2. The valve is configured to be substantially rotationally symmetrical to an axis 15.

The valve 10 substantially comprises three components, namely a base 16, a cover 17 and a diaphragm 18 which forms the movable valve element.

FIG. 4 shows a view of the base 16 from the side of the diaphragm 18, but with the diaphragm 18 having been removed. The view corresponds to a plan view from below in FIG. 3.

In the following, the three components of the valve will be described in more detail with reference to FIGS. 3 and 4.

The base 16 has a connecting piece 20 which supports a screw thread 21 and an O ring 22. The connecting piece 20 encloses an inner free passage 23. From a free opening 24, the passage 23 extends towards a space 25 which is configured to be approximately disc-shaped, is greater in diameter than the passage 23 and adjoins a floor 26 on its side remote from the passage 23.

The floor 26 has through-hole 27 coaxially to the axis 15. Provided in the radial direction further outside is a total of three openings 28 which are configured as annular segments and are approximately bean-shaped. A total of three openings 28 are shown in the figure. However, more or fewer openings can also be provided.

The plan view of FIG. 4 shows grooves 29 which have been introduced into the lower surface of the floor 26 starting from the openings 28. Thus, the grooves 29 are open towards the diaphragm denoted by reference numeral 18 in FIG. 3. They run outwards from the openings 28 with respect to the axis of symmetry 15 of the valve 10. The outer-lying end of the grooves 29 adjoins an annular ring 30 which projects over the lower surface of the floor 26. Provided radially outside the annular ring 30 is a peripheral region 31 of the base 16, which peripheral region 31 supports the cover 17 in FIG. 3.

The diaphragm 18 is rotationally symmetrical with respect to the axis 15. From inside outwards it has a mushroom-shaped peg 36 which is used to secure the diaphragm in the hole 27. In this embodiment, the peg 36 is penetrated by a central blind hole 32 and consequently can be compressed more easily during assembly. The peg 36 is surrounded on the outside by a collar 33 which forms a contact surface on the surface, surrounding the hole 27, of the floor 26. An annular diaphragm disc 35 which has a material thickness decreasing outwards from inside extends from the collar 33 towards a shoulder 34. The diameter of the diaphragm 18 is greater than the diameter of the annular ring 30 which is arranged circularly on the lower side of the base 16, concentrically to the axis 15 and to the peg 36. Therefore, the diaphragm disc 35 rests linearly with its surface facing the annular ring 30 in the normal position which is shown in FIG. 3.

The lower side of the diaphragm disc 35 is substantially planar.

The cover 17 in turn is approximately rotationally symmetrical to the axis 15. From inside outwards, the cover 17 has an elevation 40 which extends into the vicinity of the diaphragm 18 in the assembled position of FIG. 3. An adjoining bottom region 41 is penetrated by through holes 42. A graduated annular wall 43 surrounds the bottom region 41. The internal diameter of the wall 43 is configured such that the cover 17 can be pressed onto the outer peripheral surface of the base 16 with a press or transition fit.

In the assembled position of FIG. 3, the diaphragm 18 has been inserted with the mushroom-shaped region of the peg 35 into the hole 27 in the base 16. In the resting position, the diaphragm rests with its surface on the annular ring 30. The cover 17 defines a space under the diaphragm 18 and protects the diaphragm 18 against damage. In the illustrated assembled position, the valve 10 is closed. Water which penetrates through the holes 42 and reaches the diaphragm 18 from below cannot pass into the passage 23. Thus, the valve 10 protects the crankcase 7 of FIG. 1 or the crankcase 13 of FIG. 2 from water penetrating from outside.

FIG. 5 is a plan view of the cover 17, more specifically of the upper side which, in FIG. 3, faces the diaphragm 18. The components which have been described in connection with FIG. 3 are identified by the same reference numerals.

FIG. 6 shows two further exemplary embodiments which are characterised by II in the left half of FIG. 6 and by III in the right half of FIG. 6.

The connecting piece 20 encloses the passage 23. However, in this case, no thread, but instead a group of encircling ribs of projections 50 is provided on the outside of the connecting piece 20 which produce a sealing of the valve 10 when pressed into an unthreaded casing hole. In embodiment II, the base 16 is otherwise configured as in FIG. 3. The diaphragm 18 is also similar, except that the peg 36 in these two exemplary embodiments II and III is not provided with the central blind hole 32 from FIG. 3. This is an embodiment which can be produced relatively easily. It is conceivable and possible to also use for these embodiments a diaphragm 18 with a blind hole 32 in the peg 36. In II, a space 51 under the diaphragm 18 is delimited by a cover 52 which is positioned outside onto the base 16 with a press fit, as in FIG. 3, encompassing the outer periphery of the base 16. Centrally with respect to the diaphragm, the cover 52 is provided with a dome-shaped elevation 53 which extends directly up to the diaphragm 18 and almost touches the centre thereof. The radially outwardly sloping projection 53 forms a stop face for the diaphragm 18 against which the diaphragm 18 can rest when under a great load. In this way, when the diaphragm 18 undergoes extreme deflections, the surface of the projection 53 prevents the diaphragm 18 from being permanently deformed due to bending.

Embodiment III in the right half of FIG. 6 differs from embodiment II in that in this case, the base 16 is configured in the region of the cover with a tubular projection 55 which extends away from the diaphragm 18 in the axial direction. Here, the diameter of the cover 17 is smaller and the cover 17 is pressed into the tubular shoulder 55. In embodiment III, the diameter of the cover 17 is smaller than in the other embodiments. The inner cylindrical contact surface between the cover 17 and the projection 55 makes it possible for the projection 55 of the base 16 to be provided on the outside with a contour, for example with a hexagon. This is advantageous in respect of the assembly of the valve 10, namely when forces and torques have to be exerted on the joining region of the connecting piece 20. Such forces are then directly introduced and diverted out again via the base 16. In the embodiments of FIG. 3 or in embodiment II, such forces would be transmitted by the join between the cover 17 and the base 16.

In both embodiments, it is conceivable and possible to enlarge the spacing between the diaphragm 18 and the projection 53.

The two exemplary embodiments in FIG. 6 show the valve in a closed position.

FIG. 7 shows the embodiments according to FIG. 6 in the open position of the valve. In this figure, the diaphragm 18 is lifted off over its entire extent from the annular ring 30. Between the passage 23 and the openings 42 in the cover 17 is a passage through which gases and liquids can pass.

The particularly advantageous operation of the different embodiments of the valve according to the invention will be described in detail below.

As already mentioned with regard to FIG. 3, in the normal position shown in FIGS. 3 and 6, the valve 10 is closed. Water which enters from outside via the through holes 42 cannot open the valve. Therefore, at this point, the interior of the steering gear is protected against penetrating water. This applies in particular in the case of a gush of water coming from outside, which can occur, for example during instances of travelling through water when the steering is completely immersed.

On the other hand, water can penetrate inside the steering gear 11 due to defective bellows 3. Here, two cases can be distinguished.

In the first case, during submerged travel and when there is greater damage to a bellows 3, a large amount of water penetrates inside the steering gear 11. The valve remains in the closed position according to FIGS. 3 and 6, because water is also present on the lower side of the diaphragm 18. At the end of submerged travel, all the water runs towards the upper side of the diaphragm 18 and brings the diaphragm 18 into the open position according to FIG. 7 due to the dead weight of the penetrated water. Since the valve 10 is at the lowest point of the steering in the installed position of the steering, all of the penetrated water runs to the valve 10 and can there run off entirely through the gap between the diaphragm 18 and the annular ring 30.

The second case is one in which there is only slight damage to a bellows 3, for example due to gnawing by martens. Only small quantities of sprayed water caused by driving in the rain penetrate inside the steering. Drops are produced which, in the course of time, run inside the steering towards the valve 10. Such drops are basically undesirable in the steering because they increase the moisture content of the atmosphere in the steering and consequently can result in corrosion. Such quantities of drops of water run through the passage 23, the space 25 and the openings 28 to the upper side of the diaphragm 18. Here the drops would initially remain in the region between the diaphragm 18 and the openings 28 if the grooves 29 were not provided. The result of the cooperation between the grooves 29 with the respective surface characteristics of the materials used and the surface tension of the water is that the drops are conducted along the grooves 29 up to the annular ring 30. The diaphragm 18 is formed from a readily deformable material with low rebound force and thus only rests lightly against the annular ring 30 or, in the course of time, even forms a small gap between the diaphragm 18 and the annular ring 30. With a suitable configuration, the weight of the drop of water appearing radially outside on the diaphragm 18 is sufficient for the annular gap to open or for the water to flow away through the gap which is already present.

Here, it is important to mention that even if the diaphragm 18 does not always return into the fully closed position, secureness against water penetrating from below is still provided because when there is the slightest contact with water which arrives at the diaphragm from below through the holes 42, the diaphragm 18 again rests against the annular ring 30 and the valve 10 is closed at the latest at this time. A gap permanently formed in the resting state between the diaphragm 18 and the annular ring 30 is even advantageous in some cases, namely if an air exchange between the internal volume of the steering gear 11 and the external atmosphere is desired in order to keep the air inside the transmission dry by “breathing” and to prevent the occurrence of excess pressure or vacuum in the steering gear, for example due to a change in the temperature.

As suitable materials for the valve 10, plastics material has proved to be suitable for the base 16 and the cover 17. In particular, the plastics material can be selected or treated to produce hydrophobic characteristics which facilitate the passage of drops of water. The diaphragm 18 is preferably made of silicone which also conducts drops of water away without itself becoming substantially wet.

The following dimensions have proved to be advantageous in practice:

The diameter of the diaphragm 18 is between 10 mm and 30 mm, preferably 19 mm. The height of the peg 36 from the upper tip to the lower side of the diaphragm disc is between 3 mm and 8 mm, preferably 5.5 mm.

The thickness of the diaphragm disc decreases outwards from inside. On the inside, it is between 0.6 mm and 1.8 mm, preferably 1.2 mm, and accordingly outside it is between 0.45 mm and 1.35 mm, preferably 0.9 mm.

The diameter of the annular ring 30 is between 9 mm and 25 mm, preferably 17 mm. The height at which the annular ring 30 rises above the surrounding annular surface 31 is between 0.05 mm and 0.15 mm, preferably 0.10 mm. In this respect, the annular ring 30 in cross section is approximately semi-circular with a radius of between 0.05 mm and 0.15 mm.

The internal diameter of the passage 23 is between 3.5 mm and 9.5 mm, preferably 6.5 mm. Preferred as thread 21 is a thread of dimensions M10×1.0.

The grooves 29 have a depth in the direction of the axis 15 and vertically to the floor surface 26 of 0.1 mm to 0.9 mm, preferably 0.2 mm to 0.4 mm and in particular 0.3 mm. The width of the grooves is 0.5 mm to 1.5 mm, preferably 1.0 mm. The length of the grooves results from the spacing between the outer edges of the openings 28 and the annular ring 30. It is approximately 1.5 mm to 4.5 mm, preferably 3 mm. The base of the grooves can be round or rectangular.

The total diameter of the illustrated valve is 14 mm to 42 mm, preferably approximately 28 mm. The overall height of the valve from the lower side of the cover 17 to the free end of the connecting piece 20 is 9 mm to 26 mm, preferably 17 mm.

1. A water drain valve for an electromechanical motor vehicle power steering, comprising:
a base; and
a diaphragm configured as a movable valve element and arranged such that it can move relative to the base between a closed position and an open position, wherein in the closed position, the diaphragm rests against the base along an annular ring,
wherein the base includes a passage that extends from a free opening to a floor, wherein the diaphragm is attached centrally to the floor,
wherein the floor has at least one opening that forms a connection from the passage to the diaphragm,
and wherein the floor has at least one groove that is open towards the diaphragm, and which extends from the at least one opening as far as the annular ring.

2. The water drain valve according to claim 1, wherein the annular ring runs in a circular manner and concentrically encloses a central axis.

3. The water drain valve according to claim 2, wherein the at least one groove has a depth, measured in the direction of the axis and vertically to the floor surface, of 0.1 mm to 0.9 mm.

4. The water drain valve according to claim 1, wherein a width of the at least one groove is 0.5 mm to 1.5 mm.

5. The water drain valve according to claim 1, wherein the length of the at least one groove between an outer of the at least one opening and the annular ring is 1.5 mm to 4.5 mm.

6. The water drain valve according to claim 1, wherein the diaphragm comprises a round diaphragm disc which has a material thickness which decreases outwards from inside, and inside is between 0.6 mm and 1.8 mm and outside is between 0.45 mm and 1.35 mm.

7. The water drain valve according to claim 1, wherein the diaphragm is secured by a central peg in a central hole in the floor.

8. The water drain valve according to claim 7, wherein the peg has a centrally located blind hole.

9. The water drain valve according to claim 1, wherein the diaphragm is covered by a cover on its side remote from the base.

10. An electromechanical motor vehicle power steering system with a water drain valve, comprising:
a base which is arranged at a low point of a steering casing; and
a diaphragm which is configured as a movable valve element and is arranged such that it can move relative to the base between a closed position and an open position, wherein in the closed position, the diaphragm rests against the base along an annular ring,
wherein the base has a passage which is open towards an interior of the steering casing, and which extends from a free opening to a floor, wherein the diaphragm is attached centrally to the floor,
wherein the floor has at least one opening that forms a connection from the passage to the diaphragm,
and wherein the floor has at least one groove that is open towards the diaphragm, and which extends from the at least one opening as far as the annular ring.

11. The motor vehicle power steering system according to claim 10, wherein the diaphragm is mounted between the base and a cover.

12. The motor vehicle power steering system according to claim 10, wherein in a non-operating state, the diaphragm does not rest against the annular ring over its entire extent.

13. The motor vehicle power steering system according to claim 10, wherein the diaphragm and/or the base has a hydrophobic surface.

14. A motor vehicle power steering system including a water drain valve according to claim 1.
